(19) United States
(12) Patent Application Publication
(10) Pub. No.: US 2007/0159678 A1
(43) Pub. Date: Jul. 12, 2007

(54) Switchable transflector and transflective display

(76) Inventors: Nynke A.M. Verhaegh, Eindhoven (NL); Dirk K.G. De Boer, Den Bosch (NL); Mark T. Johnson, Veldhoven (NL); Bas Van Der Heijden, Hoogeloon (NL)

Correspondence Address: PHILIPS INTELLECTUAL PROPERTY & STANDARDS, P.O. BOX 3001, BRIARCLIFF MANOR, NY, 10510, US

(21) Appl. No.: 10/572,841

(22) PCT Filed: Sep. 10, 2004
(86) PCT No.: PCT/IB04/51734

§ 371 Date: Jan. 9, 2007

(30) Foreign Application Priority Data
Sep. 23, 2003 (GB) 0322231.2

(51) Int. Cl. G02F 1/15

(52) U.S. Cl. 359/265

(57) ABSTRACT

A switchable transflector (1) comprises a suspended particle device (SPD). The transflector (1) may be switched into transmissive, reflective or intermediate states by applying one or more electric fields to a particle suspension (2). An enhanced reflectivity state may be achieved by applying two mutually orthogonal electric fields simultaneously. An intermediate state may be achieved by applying a non-saturating electric field or by applying two or more electric fields alternately according to a timing scheme. The transflector (1) may be maintained in a given state by applying voltage pulses at intervals less than a relaxation time associated with the SPD 1. The transmittance and reflectance properties of the transflector (1) may be tuned in accordance with the output of a light sensor (14). The transflector (1) may be incorporated in a transflective display (15)which comprises a display device, such as an LCD (16). In order to illuminate the LCD (16), the transflector (1) is arranged to transmit light (20) emitted by a light source (17) and/or reflect ambient light (21). The relative proportions of transmitted and reflected illumination may be determin by the output of the light sensor (14).

The invention relates to a transflector comprising a suspended particle device and a transflective display comprising such a transflector.

Conventional transflective displays comprise a display device, such as a liquid crystal display (LCD), together with a light source. A transflector is located between the display device and the light source. The transflector is arranged to transmit light emitted by the light source and reflect ambient light. Illumination for the display device can be provided by the light source and from ambient light reflected by the transflector. The use of reflected illumination reduces reliance on the light source and, therefore, reduces the power consumption of the display.

The transflector may be configured to simultaneously transmit and reflect fixed fractions of incident light. For example, EP-A-1102091 discloses a on a transparent film. Its reflectance depends on the type of metal used, while its transmittance is determined by the thickness of the metal layer. A multi-layer transflector is described in EP-A-1219410, which comprises a resinous layer that is charged with a filler and/or fine powder. In this case, the transmittance depends on the concentration of the filler or powder.

Transflectors with fixed transmittance and reflectance properties are not ideal for display applications, as a significant fraction of the light from the light source is always lost. For example, the multi-layer transflectors described in EP-A-1219410 have transmittances between 20% and 60%. In this case, up to 80% of the light emitted by the light source, and therefore a significant proportion of the power supplied to the LCD, is wasted. Furthermore, the optical properties of the transflector cannot be varied in response to ambient conditions. For instance, where the display is operated in a bright environment, the reflectance cannot be increased to make greater use of reflected light.

Switchable transflectors allow light to be transmitted or reflected selectively. Examples of such transflectors are disclosed in WO-A-02/071131, US-A-2002/0036955 and WO-A-00/63745. These prior transflectors comprise metal hydride cells or polymer dispersed liquid crystal (PDLC) material or electrochromic material, which change their optical properties in response to the application of an electric field or the presence of chemical agents. WO-A-02/29484 discloses a display with a tunable transflector comprising an electrochemical device or a cholesteric liquid crystal reflector, in which transmittance and reflectance properties can be tuned in accordance with ambient conditions.

However, even with switchable systems, the power consumption of the display may be considerable, particularly where metal hydride cells or electrochromic transflectors are used. Moreover, the transmittances that can a display image of adequate brightness. In addition, metal hydride cells may have a relatively limited lifetime.

According to a first aspect of the present invention, a transflector comprises a suspended particle device.

The transflector may be configured to apply one or more electric fields to a particle suspension within the suspended particle device. The electric fields control the alignment of particles within the particle suspension, which determines the transmittance and reflectance properties of the transflector. The one or more electric fields may be applied intermittently or continuously.

The transflector may be configured so that two electric fields with mutually orthogonal field directions may be applied to the particle suspension. This allows the transflector to be switched into a highly transmissive and/or a highly reflective state by applying one or more electric fields that equal or exceed a saturation potential of the particle suspension. The saturation potential for a particle suspension is defined as the minimum potential that, when applied to the particle suspension, results in a substantially uniform particle alignment, in which the particles are aligned parallel to the electric field. The transflector may be further arranged so that both fields may be applied simultaneously, in order to attract the particles against a surface that partially encloses the particle suspension. In this state, the transflector has a particularly high reflectvity.

Optionally, the suspended particle device may be configured to allow tuning of transmittance and reflectance properties of the particle suspension to values that are intermediate to those associated with the highly transmissive and highly reflective states. Such intermediate values, “or grey” values, may be achieved by applying a non-saturating electric field or by applying two or more electric fields intermittently, according to a suitable driving scheme.

The transflector may be further configured so that its transmittance and reflectance properties are tuned in accordance with an output from an associated light sensor. For example, where the transflector is used in the provision of illumination of a display device, the transflector may be switched into a reflective state when the ambient light level exceeds a predetermined threshold, so that the display device is illuminated using reflected light. If the output from the light sensor indicates that the ambient light level is below the, threshold, the transflector may be switched into a transmissive state in order to allow the display device to be backlit by an associated light source.

According to a second aspect of the invention, a transflective display comprises a display device and a transflector, wherein said transflector is a suspended particle device.

The transflective display is arranged so that, when the transflector is in a transmissive state, the display device can be backlit by light originating from a light source that has passed through the transflector. When the transflector is in a reflective state, the display device may be illuminated using ambient light reflected by the transflector. The use of reflected lighting may reduce reliance on the light source when the display is used, when compared with prior art arrangements used in similar conditions. This, in turn, reduces the power consumption of the display. This may be particularly advantageous where the display is incorporated in portable and/or handheld equipment, where only a limited power supply may be available.

Suitable display devices for use in the transflective display include a liquid crystal device, an electrophoretic display, an electrochromic display, an electro-wetting display and a micromechanical display, such as a micro-electro-mechanical systems (MEMS) display.

Optionally, the transflective display may further comprise a quarter-wave plate to improve its operation when the transflector is in a reflective state. The quarter-wave plate may be positioned between the suspended particle device and light source, between the suspended particle device and display device or between the display device and a potential position of a viewer.

The suspended particle device may be configured so that the transmittance and reflectance of the particle suspension can be tuned in accordance with a display application and/or with ambient light conditions. In order to permit the tuning of the transflector in accordance with an ambient light level, the transflective display may further comprise a light sensor.

According to a third aspect of the invention, a method of operating a transflector comprises tuning transmittance and reflectance properties of the transflector by controlling alignments of particles within a particle suspension. The step of tuning the transflector may further comprise detecting a level of ambient light in the vicinity of the transflector, so that optical properties of the transflector may be tuned accordingly.

The transflector may be tuned by applying one or more electric fields to the particle suspension, for example, two electric fields with mutually orthogonal orientations. The one or more electric fields may be applied intermittently.

The step of tuning the transflector may include switching the transflector into one of a transmissive or reflective state, or tuning the transmittance and reflectance of the suspended particle device to intermediate values within a range of achievable transmittances and reflectances respectively.

According to a fourth aspect of the invention, a method of displaying an image comprises the steps of displaying an image on a display device and providing illumination for the display device, wherein the step of providing said illumination comprises tuning transmittance and reflectance properties of a transflector by controlling alignments of particles within a particle suspension.

The step of providing illumination for the display device may further comprise operating a light source.

The method may include detecting the level of ambient light in the vicinity of the display device. The transflector properties may be tuned in accordance with an output signal from a light sensor.

Embodiments of the invention will now be described by way of example with reference to the accompanying drawings, in which:

FIGS. 1 to 4 depict a suspended particle device in a variety of different states;

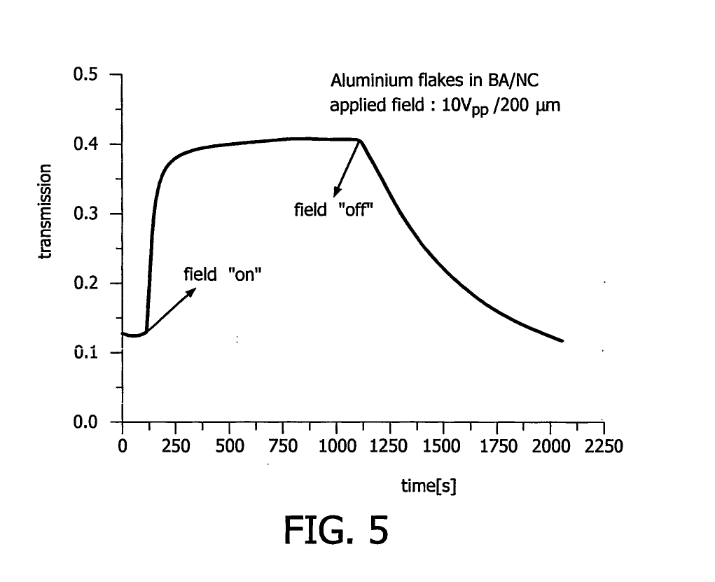

FIG. 5 is a graph of experimental data showing decay of transmittance properties in a particle suspension following the removal of an electric field;

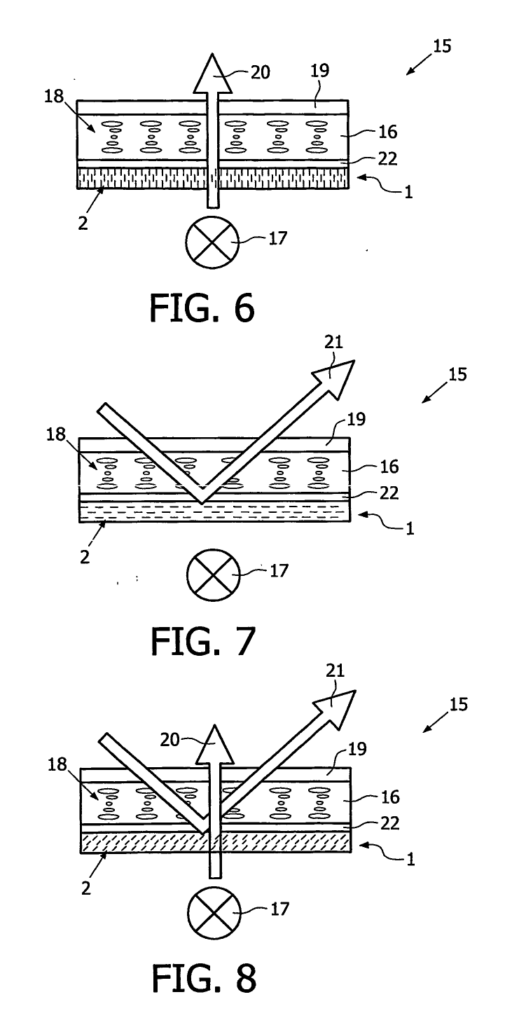

FIG. 6 is a schematic diagram of a transflective display according to the present invention in a transmissive state;

FIG. 7 is a schematic diagram showing the transflective display of FIG. 5 in a reflective state;

FIG. 8 is a schematic diagram showing the transflective display of FIG. 5 in an intermediate state;

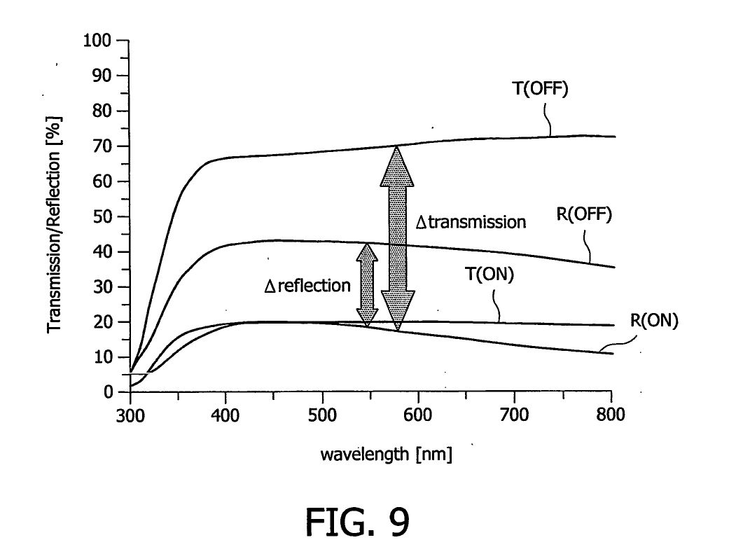

FIG. 9 is a graph showing ranges of transmissivity and reflectivity values of a suspended particle device transflector for light of various wavelengths.

FIG. 1 depicts a suspended particle device (SPD) 1 for use in a transflective display, which includes a particle suspension 2. The particle suspension 2 comprises a plurality of anisometric reflective particles suspended in an insulating fluid. Examples of suitable reflective particles include metallic particles, such as platelets of silver, aluminium or chromium, mica particles or particles of an inorganic titanium compound. Typical particle dimensions are a length and width of 10 μm and a thickness of 30 nm. However, suitable dimensions for particle lengths and widths range from 1 μm to 50 μm and thicknesses from 5 nm to 300 nm. The suspension fluid may be, for instance, butylacetate or a liquid organosiloxane polymer with a viscosity that permits Brownian motion of the particles but prevents sedimentation.

The suspension is sandwiched between a transparent plate 3, which, in this example, is made of glass, and an insulating substrate 4, made of silicon oxide (SiO₂). The plate 3 and substrate 4 are coated with a layer of conducting material 5, 6, such as indium tin oxide (ITO), which may be deposited using CVD or a sputtering process. In this example, the plate 3 and substrate 4 have thicknesses of approximately 700 μm.

Spacers 7a, 7b are provided to maintain a constant gap between the plate 3 and substrate 4. The gap between the plate 3 and substrate 4 in this example is 200 μm, although gaps within a range of 20 μm to 800 μm may be suitable, depending on the desired configuration of the SPD 1. In this particular embodiment, the spacers 7a, 7b are also coated with ITO layers 8, 9 respectively and are isolated from the ITO layers 5, 6 on the glass plate 3 and substrate 4 by thin SiO₂ passivation layers 10a, 10b, 10c, 10d.

The plate 3 and substrate 4 are not wholly covered by passivation layers 10a to 10d in order to prevent potential drops being formed between each ITO layer 5, 6 and the particle suspension 2.

The ITO layers 5, 6, 8, 9 form electrodes that can be used to apply one or more electric fields to the particle suspension 2. Although a potential drop will exist across the passivation layers 10a to 10d, between each ITO layer 5, 6 and the ITO layers 8, 9, this is taken into account when applying voltages to the particle suspension 2 and/or configuring driving schemes for the SPD 1.

The suspended particle device 1 comprises a first circuit for applying a first voltage V1 to electrodes 5, 6, comprising a first switch 11, and a circuit for applying a second voltage V2 to electrodes 8, 9, comprising a second switch 12. The suspended particle device 1 is connected to a control unit 13. The control unit 13 receives data from a light sensor 14, such as a photodiode, which detects the level of ambient light in the vicinity of the suspended particle device 1. The control unit 13 determines a desired reflectance or transmittance state for the particle suspension 2 on the basis of the data from the light sensor 14 and applies suitable voltages V1, V2 as required.

FIG. 1 shows the SPD 1 when no electric fields are applied. The particles have random alignments which are not fixed, due to Brownian motion. The particle suspension 2 is semi-opaque, or opaque, depending on the particle concentration. Therefore, the particle suspension 2 will transmit only a small fraction of any incident light.

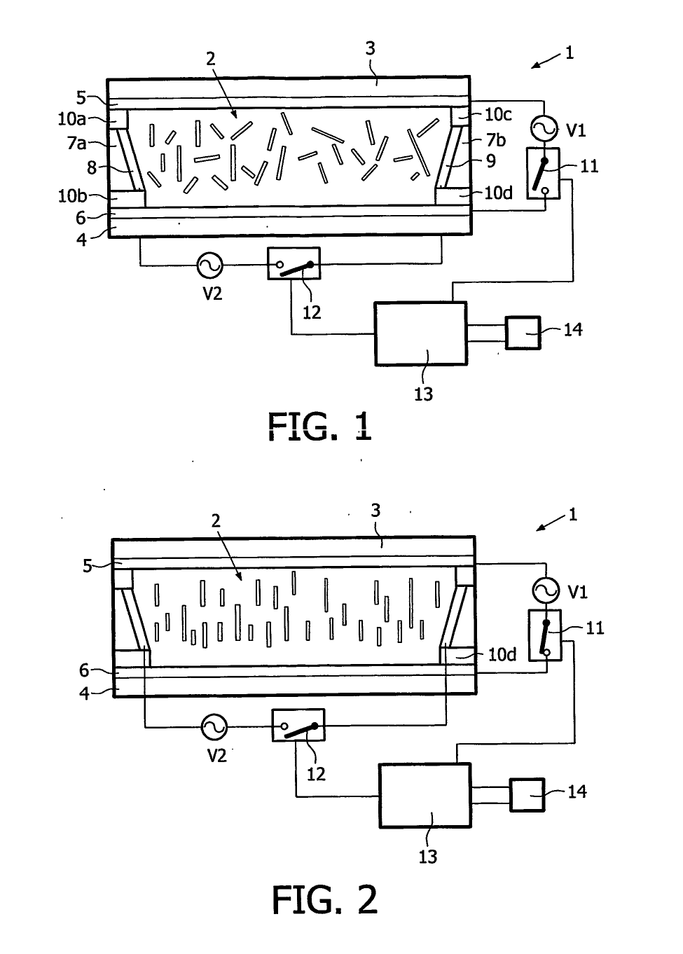

FIG. 2 shows the SPD 1 when a first voltage V1 that exceeds a saturation potential of the particle suspension 2 is applied to the electrodes 5, 6 by the control unit 13. In this example, V1 is an AC field, although the same effects may be achieved using a DC field. The resulting electric field induces a dipole in the particles. The particles align themselves with substantially uniformity so that they are parallel to the electric field lines in order to minimise energy. This raises the transmittance of the particle suspension 2, so that an increased fraction of incident light is transmitted.

in FIG. 3, a second voltage V2, which equals or exceeds the saturation potential of the particle suspension 2, is applied to ITO layers 8, 9. In this example, V2 is an AC voltage, although a DC voltage may be used instead. As noted above, the reflective particles will tend to align themselves so that they are parallel to the electric field, which increases the reflectance of the particle suspension 2. A high proportion of light passing through the glass plate 3 is reflected by the particles.

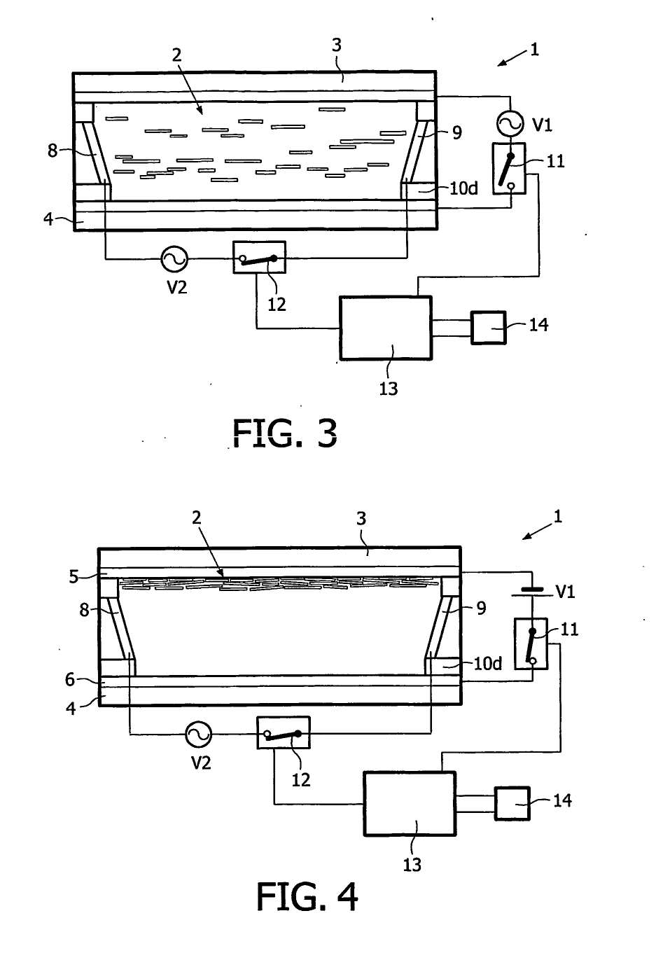

A first voltage V1 to electrodes 5, 6 and a second voltage V2 to electrodes 8, 9 may be applied simultaneously, as shown in FIG. 4. The resulting electric field causes the reflective particles to become attracted towards the plate 3, giving the particle suspension 2 a particularly high reflectance. In this example, the first voltage V1 is a DC voltage and the second voltage V2 is an AC voltage, however, similar effects may be achieved where second voltage V2 is a DC voltage. Both voltages V1, V2 are equal to, or greater than, the saturation potential. A similar enhanced reflectance state can also be attained by applying voltages V1, V2 so that the particles are attracted towards the substrate 4.

In this manner, the optical properties of the particle suspension 2 can be controlled by applying voltages V1, V2. The voltages V1, V2 may be varied in order to tune the transmittance and reflectance of the particle suspension 2 at values intermediate to those shown in FIGS. 2 to 4. For example, an intermediate value can be achieved by applying a suitable voltage V1 or V2, where the voltage V1 or V2 is less than the saturation potential of the particle suspension 2. The resulting alignment of particles in particle suspension 2 is neither parallel to nor perpendicular to the electrodes 5, 6. Alternatively, an intermediate value may be achieved by applying voltages V1 and V2 as a series of alternate pulses. The particle alignments are then continually switched between two or more states. In this case, the intermediate value achieved depends on the particle alignments in these states and the relative length of time that the particles spend in each state, in accordance with the driving scheme used to appiy the voltages V1, V2.

When an applied voltage V1, V2 is switched off, by opening the and gradually return to the state shown in FIG. 1, where their alignments are random and change over time. The period of time required for the particles to return to this state may be considerable. This time period is referred to hereafter as the relaxation time.

FIG. 5 is a graph of experimental data showing the transmittance of a suspension of aluminium platelets. At time t=100 s, a voltage V1 is applied as shown in FIG. 2, causing the particle suspension to become transmissive. The graph shows that the particles are re-aligned in response to the applied voltage within a time period of approximately 60 s. This time period is hereafter referred to as a reaction time.

At time t=1100 s, the voltage is switched off. The graph shows that, while, when the transmittance decays to approximately 25% of its maximum value after a time period of approximately 1000 s.

It should be noted that the values for the reaction and relaxation times derived from FIG. 5 are examples only. The reaction and relaxation times for a given particle suspension will depend on the properties of the particles and suspension fluid, the volume of the particle suspension, the voltage applied and/or driving scheme used to apply the voltage.

The relaxation time is relatively long when compared with the reaction time and can be exploited as follows. In order to maintain the particle suspension 2 in a given transmissive or reflective state, one or more appropriate voltages V1, V2 can be applied intermittently, as a series of pulses. For example, voltage V1 may be initially applied for a short time period ti corresponding to the reaction time so that the particles are aligned as shown in FIG. 2. In the example of FIG. 5, the reaction time is of the order of 60 s. The voltage V1 may then be switched off, over which the uniform particle alignment, and therefore the transmittance, begins to decay. After a predetermined time interval t2, before the transmittance of the particle suspension 2 has degraded significantly, voltage V1 may be re-applied for a second short period of time t1 in order to “refresh” the particle alignment. In the example of FIG. 5, a suitable time interval t2 would be about 150 s. Voltage V1 may be re-applied after subsequent time intervals so that the optical properties of the particle suspension 2 are maintained within an acceptable range. As a constant electric field is not required, the power requirements of the SPD 1 are relatively low.

As shown in FIG. 6, the SPD 1 is used as a transflector in a transflective display 15, which further comprises a liquid crystal (LC) cell 16 and a light source 17. The SPD 1 is positioned so that light emitted by the light source 17 passes through the particle suspension 2 before entering the LC cell 16.

The LC cell 16 comprises liquid crystal material 18 and a polariser 19, together with a matrix of column (select) and row (addressing) electrodes, not shown, or an array of thin-film transistors (TFTs), not shown, which define an array of pixels. Other components also not shown in FIG. 5 include electrodes for use in controlling the TFTs, where the LC cell 16 comprises a TFT array, and colour filters associated with each pixel. The structure and operation of such an LC cell 16 is well known per se.

When data output by the light sensor 14 indicates that the ambient light level in the vicinity of the transflective display 15 is below a predetermined threshold, the control unit 13 closes switch 11 and applies a voltage V1 across electrodes 5, 6, as shown in FIG. 2. As a result, the transmittance of the particle suspension 2 is maximised, as shown in FIG. 6. A high proportion of light 20 emitted by the light source 17 can then pass through the SPD 1 and propagate through the LC cell 16, so that the LC cell 16 is backlit by the light source 17.

The light 20 emitted by the light source 17 may have a wide angular distribution. However, the aligned particles act to collimate the light passing through the particle suspension 2, so that the resulting backlighting has a relatively narrow angular distribution. This means that a considerable fraction of the light 20 may be scattered by the particles and wasted. The efficiency of the SPD 1 in its transmissive state may be improved by using a suspension liquid with a high refractive index, so that an increased fraction of the light 20 passes through the particle suspension 2. An example of a suitable high refractive index suspension fluid is FC75. FC75 has a refractive index of 1.6, whereas the refractive index of butylacetate is 1.4.

When the output of the light sensor 14 indicates that the ambient light is above the predetermined threshold, the transflector 1 may be switched into a reflective state in order to use ambient light 21 as a source of lighting for the LC cell 16. FIG. 7 shows the transflective display 15 when voltage V2 is applied by the control unit 13, with switch 12 closed as shown in FIG. 3. Ambient light 21, that is light produced by sources external to the display 15, propagates through the LC cell 16 and is incident on the SPD 1. The ambient light 20 is reflected by the particle suspension 2 and passes back through the LC cell 16, thereby illuminating the LC cell 16. As most of the light 20 emitted by the light source 17 would be reflected or scattered by the particle suspension 2, and therefore wasted, the light source 17 is switched off in order to conserve power.

Depending on the configuration of the LC cell 16, a quarter-wave plate 22 may be provided in order to ensure that the transmitted light 20 and reflected light 21 are of the correct polarisation to pass through the polariser 19 in the LC cell 16. The quarter-wave plate may be positioned between the LC cell 16 and SPD 1, as shown, or placed on the opposite side of the LC cell 16, so that incident light 21 passes through the quarter-wave plate 22 before entering the LC cell 16 and SPD 1.

The SPD 1 may also be switched into the enhanced reflectivity state of FIG. 4 may also be used when detected ambient light conditions are close to the predetermined threshold. However, there is some advantage in utilising this enhanced reflectivity state whenever reflected illumination is required. When the SPD 1 is in the reflective state shown in FIGS. 3 and 7, the separation between the LC cell 16 and the reflecting surface, that is the surfaces of the particles themselves, may be up to 1 mm. This reduces the resolution of the image when viewed at a wide angle. This effect can be mitigated by switching the SPD into the highly reflective state, depicted in FIG. 4, when reflected illumination is required. Voltages V1, V2 are applied simultaneously by the control unit 13, as shown in FIG. 4. In addition to enhancing the reflectance of the particle suspension 2, this minimises the distance between the reflecting surfaces and the LC cell 16 so that any deterioration in resolution is reduced.

The transmittance and reflectance of the particle suspension 2 can be tuned to intermediate values by applying a suitable voltage V1 and/or V2, where the voltage V1 or V2 is less than the saturation potential of the particle suspension 2, so that the particle alignment is not exactly parallel with the electric field lines. The resulting alignment of particles in particle suspension 2 is therefore neither parallel to nor perpendicular to the electrodes 5, 6. Alternatively, an intermediate value may be achieved by applying voltages V1 and V2 as a series of alternate pulses. The particles then switch between two alignments, corresponding to the directions of the resulting electric fields. The reflectance and transmittance properties of the particle suspension 2 then depends on the relative proportions of time that the particles spend in each state, which is governed by a driving scheme used to apply voltages V1, V2.

Illumination for the LC cell 16 is then provided through a combination of light 20 from the light source 17 and reflected light 21, as shown in FIG. 8. This may be necessary where the intensity of the ambient light 21 is too low to provide a sufficient level of illumination, as indicated by the light sensor 14.

In this manner, the LC cell 16 may be illuminated using light 20 transmitted and light 21 reflected by suspended particle device 1.

FIG. 9 shows experimental data for transmittance and reflectance of incident light of various wavelengths that can be achieved in a SPD 1 comprising aluminium platelets. The upper transmittance and reflectance limits shown in FIG. 9 correspond to the platelets being aligned as shown in FIGS. 2 and 3 respectively, while the lower limits of these properties are those obtained when no electric field is applied, that is, where the platelets are aligned randomly as shown in FIG. 1. In this experiment; upper transmittance limits in a range of 65% to 70% and reflectances of 35% to 42% were achieved for incident light with a wavelength between 400 and 800 nm.

These combined values compare favourably with the transmittance and reflectance of fixed transflectors discussed above. For example, while the transflectors disclosed in EP-A-1219410 have reflectances of up to 57%, their transmittances are between 20% and 60%, while the transflector with the highest transmittance of those disclosed in EP-A-1102091 has a reflectance between 40% and 60% and a transmittance of 30% to 50%. Therefore, the present transflective display 15 is capable of transmitting light 20 with greater efficiency, resulting in reduced wastage of light 20 and power.

While these values are comparable or superior to those achieved with, for example, switchable transflectors comprising liquid crystal material, the power requirements of the SPD 1 are typically lower than those associated with liquid crystal transflectors and other types of switchable transflectors such as metal hydride cells or electrochromic cells.

The reflectance values shown in FIG. 9 may be further improved by one or more of the following: increasing the particle concentration, applying a second voltage V2 as shown in FIG. 4, and/or using other combinations of particles and suspension fluid, voltage levels or driving schemes. For example, a reflectance greater than 80% can be achieved with a particle suspension in the enhanced reflectivity state shown in FIG. 4.

The display may be incorporated in, for example, communication devices or computing equipment, whether fixed or portable. The display is particularly suitable for mobile equipment, such as mobile telephones, personal digital assistants, handheld televisions etc. These devices may be required to operate with a limited power supply, such as power supplied from a rechargeable battery. The use of reflected backlighting may reduce the need to operate the light source 17, in terms of duration and/or intensity of light 16, so that the light source 17 consumes less power.

From reading the present disclosure, other variations and modifications will be apparent to persons skilled in the art. Such variations and modifications may involve equivalent and other features which are already known in the design, manufacture and use of electronic devices comprising liquid crystal or other displays or suspended particle devices and component parts thereof and which may be used instead of or in addition to features already described herein.

In particular, the SPD 1 may contain a number of spacers 7a, 7b, defining a plurality of compartments for housing separate particle suspensions 2. The spacers 7a, 7b defining each compartment may be, if required, be equipped with electrodes 8, 9 for applying voltage V2 to the particle suspensions 2. In such an embodiment, the spacers 7a, 7b would be disposed at intervals within a range of 20 μm to 800 μm, for example 200 μm.

More than one pair of electrodes 8, 9 may be provided for applying a second voltage V2 to a particle suspension 2 whether the SPD 1 comprises single or multiple particle suspensions 2, permitting the application of inhomogeneous electric fields.

Display devices other than an LC cell 16 may be used in a transflective display 15 in combination with the transflector 1. Suitable alternative displays include electrophoretic displays, electrochromic displays, electro-wetting displays and micromechanical displays, such as micro-electro-mechanical systems (MEMS) displays.

Other materials may be used to form the particle suspension 2, plate 3, substrate 4 or electrodes 5, 6, 8, 9. For example, the plate 3 may be formed using transparent plastic material instead of glass. The substrate 4 may also be formed from a different transparent material, such as glass, quartz or plastic. The electrodes 5, 6, 8, 9 may be formed using a transparent electrically conductive film of material other than ITO, such as tin oxide (SnO₂). Other suitable materials for the electrodes 8, 9 include conducting polymer, silver paste and metals such as copper, nickel, aluminium etc., deposited onto the spacers 7a, 7b by electroplating or printing.

Furthermore, the particle suspension 2 may be a liquid with reflective particles suspended within it, or a film encasing droplets of suspension fluid, the reflective particles being suspended within the droplets.

The electrodes 8, 9 may be omitted so that the SPD 1 is arranged to apply a single voltage V1 across electrodes 5, 6. In such an embodiment, the transflector can be switched between a transmissive state, shown in FIG. 2, and the disordered state shown in FIG. 1. However, without means for applying a second electric field, such as electrodes 8, 9, the reflective states shown in FIGS. 3 and 4 cannot be achieved.

The quarter-wave plate 22 is shown in FIGS. 6 to 8 as positioned between the LC cell 16 and SPD 1 and, as noted above, the quarter-wave plate 22 may be located on the opposite side of the LC cell 16, so that incident light 21 passes through the quarter-wave plate 22 before entering the LC cell 16 and SPD 1. Although the quarter-wave plate 22 enhances the performance of the transflective display 15 when using reflected illumination, the quarter-wave plate 22 may instead be positioned between the light source 17 and SPD 1, so that it acts on light 20 from the light source 17 only. Alternatively, the quarter-wave plate 22 may be omitted altogether without departing from the scope of the invention.

The SPD 1 may be configured to apply constant or intermittent electric fields or fields of both types.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. A transflector comprising a suspended particle device (1).

2. A transflector according to claim 1, wherein the suspended particle device (1) is configured to apply one or more electric fields to a particle suspension (2).

3. A transflector according to claim 2, wherein the suspended particle device (1) is configured to apply to the particle suspension (2) two-electric fields with mutually orthogonal orientations.

4. A transflector according to claim 2, wherein the suspended particle device (1) is configured to apply an electric field to the particle suspension (2) intermittently.

5. A transflector according to claim 1, wherein the suspended particle device (1) is configured to switch the particle suspension (2) into one of:
a transmissive state; and
a reflective state.

6. A transflector according to claim 5, wherein the suspended particle device (1) is configured to tune transmittance and reflectance properties of the particle suspension (2) to values intermediate to those associated with said transmissive and reflective states.

7. A transflector according to claim 1, further configured to tune its transmittance and reflectance properties in accordance with an output of a light sensor (14).

8. A transflective display (15) comprising:
a display device (16); and
a transflector (1);
wherein said transflector (1) is a suspended particle device.

9. A transflective display (15) according to claim 8, wherein the suspended particle device (1) is configured to apply one or more electric fields to a particle suspension (2).

10. A transflective display (15) according to claim 9, wherein the suspended particle device (1) is configured to apply to the particle suspension (2) two electric fields with mutually orthogonal orientations.

11. A transflective display (15) according to claim 9, wherein the suspended particle device (1) is configured to apply an electric field to the particle suspension (2) intermittently.

12. A transflective display (15) according to claim 8, wherein the suspended particle device (1) is configured to switch the particle suspension (2) into one of:
a transmissive state; and
a reflective state.

13. A transflective display (15) according to claim 12, wherein the suspended particle device (1) is configured to tune transmittance and reflectance properties of the particle suspension (2) to values intermediate to those associated with said transmissive and reflective states.

14. A transflective display (15) according to claim 8, wherein the display device (16) is a liquid crystal display device.

15. A transflective display (15) according to claim 8, wherein the display device (16) is one of:
an electrophoretic display;
an electrochromic display;
an electro-wetting display; and
a micromechanical display.

16. A transflective display (15) according to claim 8, further comprising a light source (17).

17. A transflective display (15) according to claim 8, further comprising a quarter-wave plate (22).

18. A transflective display (15) according to claim 16, further comprising a quarter-wave plate (22) positioned between the suspended particle device (1) and light source (17).

19. A transflective display (15) according to claim 1, further comprising a light sensor (14).

20. A method of operating a transflector (1), comprising tuning transmittance and reflectance properties of the transflector (1) by controlling alignments of particles within a particle suspension (2).

21. A method according to claim 20, further comprising:
detecting a level of ambient light (21) in the vicinity of the transflector (1).

22. A method of displaying an image, comprising the steps of:
displaying an image on a display device (16); and
providing illumination for a display device (16);
wherein the step of providing said illumination comprises tuning transmittance and reflectance properties of a transflector (1) by controlling alignments of particles within a particle suspension (2).

23. A method according to claim 22, wherein the step of providing illumination for the display device (16) further comprises operating a light source (17).

24. A method according to claim 22, further comprising:
detecting a level of ambient light in the vicinity of the display device (16).

25. A method according to claim 20, wherein the transflector (1) is tuned in accordance with an output signal of a light sensor (14).

26. A method according to claim 20, wherein the tuning of the transflector (1) comprises applying one or more electric fields to the particle suspension (2).

27. A method according to claim 26, wherein the tuning of the transflector (1) comprises applying to the particle suspension (2) two electric fields with mutually orthogonal orientations.

28. A method according to claim 26, wherein the one or more electric fields are applied to the particle suspension (2) intermittently.

29. A method according to claim 20, wherein the step of tuning the transflector (1) comprises switching the particle suspension (2) into one of;
a transmissive state; and
a reflective state.

30. A method according to claim 20, wherein the step of tuning the transflector (1) comprises tuning its transmittance and reflectance properties to intermediate values within a range of achievable transmittances and reflectances respectively.
